(19) United States
(12) Patent Application Publication
(10) Pub. No.: US 2005/0201270 A1
(43) Pub. Date: Sep. 15, 2005

(54) Method and apparatus for transmitting and receiving pilot signals in an orthogonal frequency division multiple access system

(75) Inventors: Seong-Wook Song, Gwacheon-si (KR); Young-Mo Gu, Suwon-si (KR); Min-Goo Kim, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/078,620

(22) Filed: Mar. 14, 2005

(30) Foreign Application Priority Data
Mar. 13, 2004 (KR) 2004-17186

(51) Int. Cl. H04B 7/216; H04J 11/00

(52) U.S. Cl. 370/208; 370/210; 370/491

(57) ABSTRACT

A method and apparatus are provided for transmitting and receiving pilot signals to estimate link gains and channels of neighboring base stations in an orthogonal frequency division multiple access (OFDMA) system. Each base station cyclically shifts a frequency domain signal of the same pseudo random (PN) code by a predetermined multiple of a time interval between pilots. A mobile terminal cyclically shifts a time domain pilot signal by a time interval between pilots associated with a base station with which the mobile terminal currently communicates in a reverse direction of cyclic shift of the base station, and estimates a channel and a link gain of the base station.

### PRIORITY

This application claims the benefit under 35 U.S.C. 119(a) of an application entitled “METHOD AND APPARATUS FOR TRANSMITTING AND RECEIVING PILOT SIGNALS IN AN ORTHOGONAL FREQUENCY DIVISION MULTIPLE ACCESS SYSTEM”, filed in the Korean Intellectual Property Office on Mar. 13, 2004 and assigned Serial No. 2004-17186, the entire contents of which are incorporated herein by reference.

### BACKGROUND OF THE INVENTION

1. Field of the Invention

The present invention relates generally to a method and apparatus for transmitting and receiving pilot signals in an orthogonal frequency division multiple access (OFDMA) system. More particularly, the present invention relates to a method and apparatus for transmitting and receiving pilot signals that can remove interference components by estimating channels and link gains for power control.

2. Description of the Related Art

Current mobile communication systems are developing into a fourth generation (4G) mobile communication system for providing a very high-speed multimedia service subsequent to the third generation (3G) mobile communication system for providing a high-speed multimedia service after the first generation (1G) mobile communication system serving as an analog system and the second generation (2G) mobile communication system serving as a digital system.

The 4G mobile communication system allows one mobile terminal to use all the services provided by a satellite network, a wireless local area network (LAN), an Internet network, and so on. That is, one mobile terminal can receive all services for providing voice, images, Internet data, voice mail, instant messages (IMs), and so on. The 4G mobile communication system seeks to provide a transmission rate of approximately 20 Mbps in order to provide a very high-speed multimedia service, and uses orthogonal frequencies such as an orthogonal frequency division multiplexing (OFDM) technique.

The OFDM technique serves as a digital modulation scheme for multiplexing orthogonal multicarrier signals, and divides a single data stream into a plurality of low speed streams to simultaneously transmit the streams using multiple subcarriers at a low transmission rate. Accordingly, symbol duration is extended, such that dispersion is relatively reduced due to path delay spread in the time domain.

In an orthogonal frequency division multiple access (OFDMA) system, data is transmitted in units of symbols. In this case, intersymbol interference occurs. To compensate for the intersymbol interference, the OFDMA system inserts, into a symbol, a cyclic prefix (CP), which is longer than the length of a communication channel. This symbol structure is illustrated in FIG. 1. In FIG. 1, the CP corresponds to a hatched part. A rear part of the symbol is copied and the copied symbol part based on a guide time T_{g} is fixed before a front part of the symbol. A time of a symbol part except the CP is denoted by T_{b}, and the total symbol time is denoted by Tₛ.

After a received signal undergoes a CP removal operation and a fast Fourier transform (FFT) operation when the number of used subcarriers is N, a relationship between the received and the transmitted signals is expressed as Equation 1. In Equation 1, k denotes a subcarrier index.
z(k)=H(k)s(k)+w(k) (1)

In Equation 1, z(k) denotes a signal after performing a FFT operation on a received signal, s(k) denotes a subcarrier signal, w(k) denotes an intersymbol interference value, that is, a noise value, and H(k) denotes a N-point discrete Fourier transform (DFT) value of a time domain channel response h[n]. A mobile terminal must estimate a H(k) value of a channel to demodulate the signal received from a base station. For this, the base station inserts a pilot signal into a downlink data packet and transmits the downlink data packet into which the pilot signal has been inserted. The mobile terminal can perform channel estimation using the pilot signal.

In a multiple access technique, the mobile terminal estimates signal to interference plus noise ratio (SINR) information to use the pilots for power control, and transmits the estimated SINR information to the base station. When the multiple access technique is performed, a signal after performing an FFT operation on a received signal in the mobile terminal is defined by Equation 2. It is assumed that the total number of base stations is K, the number of base stations interfering with the Mobile Terminal 1 is K−1, and the total number of subcarriers is N. In this case, a relationship between a transmitted signal of Base Station 1 and a received signal of Mobile Terminal 1 can be expressed as Equation 2:

$${z}_{1} ( k ) = {H}_{1 , 1} ( k ) {s}_{1} ( k ) + {\sum }_{l = 2}^{K} {H}_{l , 1} ( k ) {s}_{l} ( k ) + w ( k ) \qquad ( 2 )$$

In Equation 2, z₁(k) is a signal after performing the FFT operation on a received signal in Mobile Terminal 1, H_{l,j}(k) is a channel response of a k-th subcarrier between Base Station i and Mobile Terminal j, sₗ(k) is a signal transmitted from an l-th base station through the k-th subcarrier, and w(k) is additive noise in the k-th subcarrier.

A SINR Γᵢ in Mobile Terminal i is expressed as Equation 3:
Γᵢ=PᵢGᵢᵢ/Iᵢ (3)

In Equation 3, Gᵢᵢ is a link gain between Base Station i and Mobile Terminal i, Pᵢ is a transmission power of Base Station i, and Iᵢ is an interference power in Mobile Terminal i.

Iᵢ in Equation 3 is expressed as Equation 4:

$${I}_{i} = {\sum }_{j \neq i} {P}_{k} {G}_{j , i} + {N}_{0} \qquad ( 4 )$$

In Equation 4, N₀ is additive noise power, and Pₖ is transmitter power of a k-th subcarrier.

When Terminal 1 communicates with Base Station 1, it needs to estimate H_{1,1}(k) of a channel to demodulate a signal received from Base Station 1. Mobile Terminal 1 estimates the channel using a pilot signal s₁(k) specified by negotiation between Mobile Terminal 1 and Base Station 1 during a training period. As seen from Equation 2, interference components

$${\sum }_{l = 2}^{K} {H}_{l , 1} ( k ) {s}_{l} ( k )$$

from other base stations serve as noise. When interference increases, a channel estimation error increases. Accordingly, interference components need to be removed such that the accuracy of a channel estimate can be increased. If pilot signals of base stations are accurately designed, interference can be reduced.

Because a frequency reuse factor is reduced to increase the number of subscribers in an Institute of Electrical and Electronics Engineers (IEEE) 802.16d or 802.16e system for broadband wireless communication, there is a problem in that interference in the system increases compared to an existing cellular system. Accordingly, the OFDMA system needs to improve power control such that interference can be minimized and the communication quality can be improved.

A power control technique includes a centralized power control algorithm, a decentralized power control algorithm, and so on. The centralized power control algorithm estimates link gains G_{i,j} between all Base Stations i and Mobile Terminal j associated with an SINR and controls transmission power Pᵢ of Base Station i such that an SINR Γᵢ required by Mobile Terminal j is satisfied. Without making use of all link gain information G_{i,j}, the decentralized power control algorithm performs a control operation such that an SINR Γᵢ required by all mobile terminals can be satisfied using only a link gain G_{i,j} between Base Station i and Mobile Terminal i in a communication state, and an estimate of Iᵢ when it is assumed that Base Station i and Mobile Terminal i communicate with each other. The centralized power control algorithm has excellent performance. However, it is impossible for the centralized power control algorithm to accurately estimate all link gains G_{i,j} necessary for power control in actual implementation. Accordingly, the decentralized power control algorithm is generally used in spite of performance degradation associated therewith.

A conventional pilot arrangement method of a base station includes a method for applying some pilot subcarriers to carriers of each symbol at equivalent power intervals or using fixed and variable pilot subcarriers, or a method for using all subcarriers of one symbol as pilots.

A conventional method for generating a pilot signal in the base station includes a method based on a pseudo random code as in IEEE 802.16d, which is incorporated herein by reference and a method based on a pseudo random code and a Walsh code as in IEEE 802.16e, which is incorporated herein by reference.

Because the above-mentioned conventional methods do not take into account a link gain for power control in any pilot signal arrangement combination, and use the same pseudo random code in a pilot, interference power is present in all time zones, and interference between pilots of neighboring base stations occurs.

### SUMMARY OF THE INVENTION

Accordingly, the present invention has been designed to solve the above and other problems occurring in the prior art. Therefore, it is an aspect of the present invention to provide a method and apparatus for transmitting and receiving time domain pilot signals such that channels and link gains between a mobile terminal and base stations can be estimated and individually separated.

It is another aspect of the present invention to provide a method and apparatus for transmitting and receiving pilot signals that can obtain an improved channel estimate by defining an interference power in a specific time domain and removing interference components correlated with an estimation error in a channel estimation algorithm.

The above and other aspects of the present invention can be achieved by a method for estimating link gains and channels of neighboring base stations in an orthogonal frequency division multiple access (OFDMA) system. The method includes outputting time domain pilot signals to be transmitted by delaying a generated frequency domain signal of the same pseudo random (PN) code by a predetermined multiple of a time interval between the pilot signals in each base station; and estimating a channel and a link gain of a time domain associated with a base station with which the mobile terminal desires to communicate by delaying a transmitted time domain pilot signal by a delay time between pilots associated with the base station in the mobile terminal.

The above and other aspects of the present invention can be achieved by an apparatus for generating time domain pilots to be transmitted from base stations such that link gains and channels are estimated in an orthogonal frequency division multiple access (OFDMA) system. The apparatus includes pseudo random (PN) code generators for generating frequency domain signals of the PN code; inverse fast Fourier transform (IFFT) processors for transforming the frequency domain signals of the PN code into time domain signals; a delay unit for delaying each of the time domain signals by a predetermined multiple of a time interval between pilots; and parallel-to-serial (P/S) converters for inserting cyclic prefixes (CPs) into the time domain signals, and outputting time domain pilot signals to be transmitted.

The above and other aspects of the present invention can be achieved by an apparatus for estimating channels and link gains from time domain pilots transmitted by base stations in a mobile terminal to remove interference components of neighboring base stations using the same pseudo random (PN) code in an orthogonal frequency division multiple access (OFDMA) system. The apparatus includes a fast Fourier transform (FFT) processor for transforming the transmitted time domain pilots into frequency domain signals, multiplying the frequency domain signals by conjugate signals of the pilots, and transforming, into time domain signals, the frequency domain signals from which PN codes have been removed; and an estimator for estimating channels and link gains associated with the base stations from the time domain signals.

### BRIEF DESCRIPTION OF THE DRAWINGS

The above and other aspects and advantages of the present invention will be more clearly understood from the following detailed description taken in conjunction with the accompanying drawings, in which:

FIG. 1 illustrates a conventional symbol structure in an orthogonal frequency division multiple access (OFDMA) system;

FIG. 2 illustrates cells in which pilot signals having different delays are arranged in an OFDMA system in accordance with an embodiment of the present invention;

FIG. 3 is a block diagram illustrating base stations for transmitting time domain pilot signals in accordance with an embodiment of the present invention;

FIG. 4 illustrates a process for computing channel estimates and link gain estimates from received pilot signals in a mobile terminal in accordance with an embodiment of the present invention;

FIG. 5 is a block diagram illustrating base stations for transmitting time domain pilot signals in accordance with an embodiment of the present invention;

FIG. 6 illustrates a process for computing channel estimates and link gain estimates from received pilot signals in a mobile terminal in accordance with an embodiment of the present invention;

FIG. 7 is a graph illustrating delayed signals assigned to cells in accordance with an embodiment of the present invention;

FIG. 8 is a graph illustrating the magnitude of a time domain pilot signal x,[n] from Base Station 1 taking into account a pseudo random code and a delay time in accordance with an embodiment of the present invention;

FIG. 9 is a graph illustrating a time domain signal after inverse fast Fourier transform (IFFT) for channel estimation of the mobile terminal in accordance with an embodiment of the present invention; and

FIG. 10 is a graph illustrating a comparison of channel estimation errors in accordance with an embodiment of the present invention.

Throughout the drawings, the same element is designated by the same reference numeral or character.

### DETAILED DESCRIPTION OF EXEMPLARY EMBODIMENTS

Embodiments of the present invention will be described in detail herein below with reference to the accompanying drawings. In the following description, a detailed description of known functions and configurations incorporated herein will be omitted for conciseness.

In accordance with an embodiment of the present invention, base stations transmit pilot signals, and a mobile terminal receives the pilot signals to estimate channels and link gains. The objects of the present invention can be achieved by means of two embodiments. A first embodiment cyclically shifts a time domain signal by a multiple of a pilot signal delay between the base stations and transmits a time domain pilot signal from a base station. A second embodiment delays phase of a frequency domain signal by a multiple of a pilot signal delay between the base stations and transmits a time domain pilot signal from a base station.

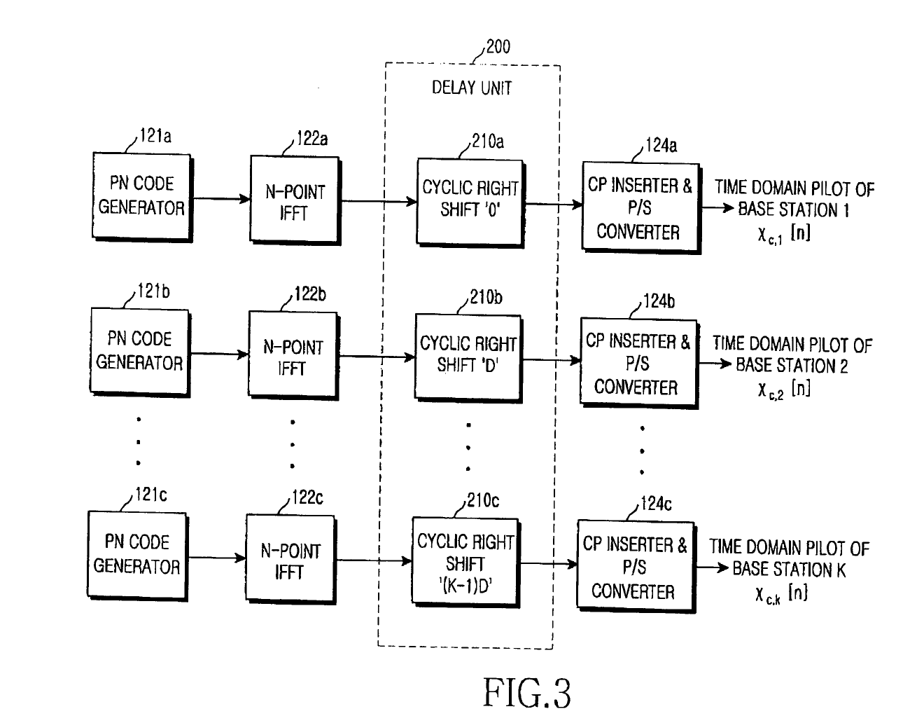

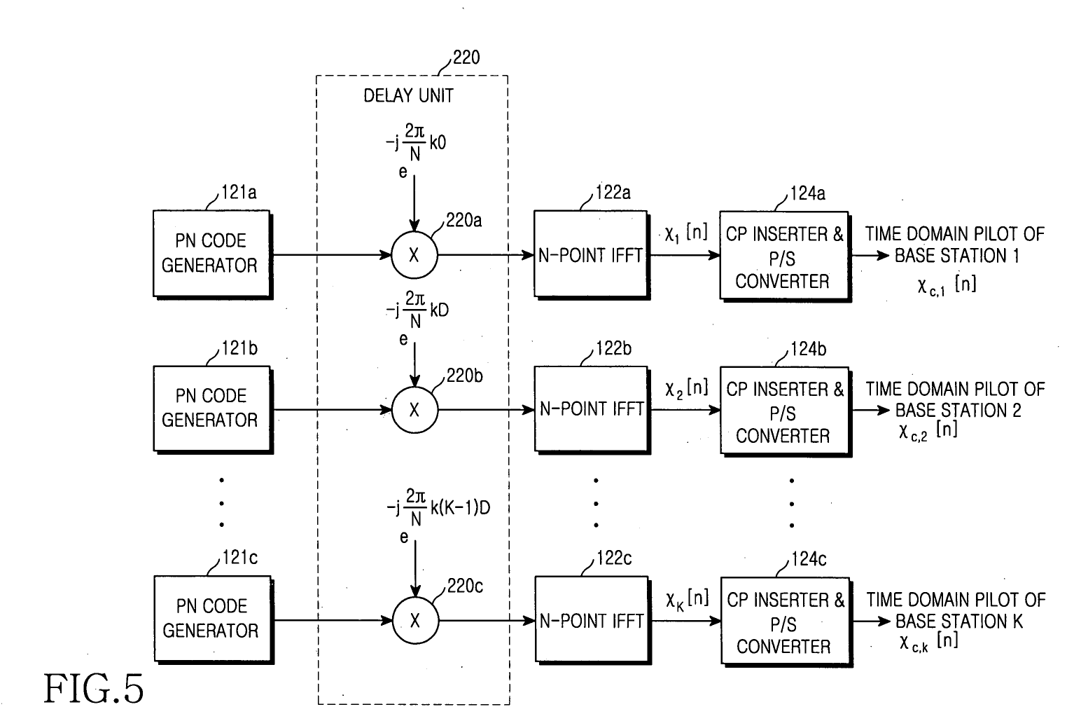

FIGS. 3 and 5 illustrate block diagrams illustrating components of a base station in accordance with the first and second embodiments of the present invention, respectively. Because a mobile terminal performs the inverse process of the base station of FIG. 3 or 5, it can be constructed according to the inverse process of the base station of FIG. 3 or 5. Accordingly, details of the mobile terminal are omitted for convenience.

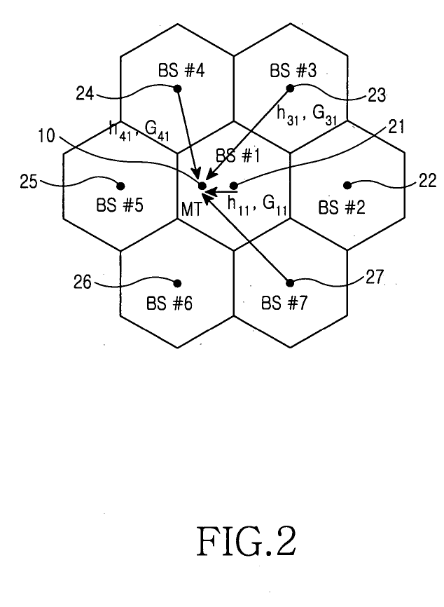

FIG. 2 illustrates cells in which pilot signals having different delays are arranged in an orthogonal frequency division multiple access (OFDMA) system in accordance with an embodiment of the present invention, and FIG. 3 is a block diagram illustrating an apparatus for generating pilot signals in base stations in the OFDMA system in accordance with the first embodiment of the present invention.

Referring to FIG. 2, pilot signals having different delay times are arranged according to Base Stations #1 to #7 denoted by reference numerals 21 to 27 within cells of the OFDMA system. When a condition of L<D=N/K for the cells is satisfied where L is a channel length, K is the number of base stations, and N is the number of fast Fourier transform (FFT) points, the pilot signal arrangement for the base stations 21 to 27 in the time domain is provided in accordance with an embodiment of the present invention. The base stations 21 to 27 assign pilot signals with a delay time corresponding to a multiple of a time interval D between pilots without overlapping. In this case, because the time interval D between the pilots is greater than the channel length even though a pilot signal passes through a communication channel, a mobile terminal 10 differentiates time domain signals received from the base stations 21 to 27.

If pilot delay times associated with the base stations 21 to 27 interfering with the mobile terminal 10 are known to the mobile terminal 10 when it communicates with the base station 21, the mobile terminal 10 can compute communication link gains associated with the base stations, such as a communication link gain G_{i,j} between Base Station i and Mobile Terminal j, necessary for centralized power control using values associated with channels between other base stations 22 to 27 and the mobile terminal 10. However, when an impulse signal is used, a pilot may be distorted due to impulse noise and a large channel estimation error may occur. To avoid the distortion and the estimation error, the impulse pilot is spread using a pseudo random (PN) code and a pilot robust against the impulse noise is generated. In actual implementation, because an orthogonal frequency division multiplexing (OFDM)-based pilot is generated in the frequency domain, the PN code is applied in the frequency domain. Accordingly, pilots can be expressed as Equation 5:

$${p}_{1} [ n ] = c [ n ] , \\ {p}_{2} [ n ] = c [ {( n - D )}_{N} ] , \\ ⋮ \\ {p}_{K} [ n ] = c [ {( n - ( K - 1 ) D )}_{N} ] \qquad ( 5 )$$

In Equation 5, c[n] is a PN code, ( )_{N} is a modulo-N operation, K is the number of base stations, and D is a basic unit of cyclic delay between base stations, and n is a time index.

A structure of the base stations for transmitting time domain pilot signals will be described with reference to the accompanying drawings.

FIG. 3 is a block diagram illustrating base stations for transmitting time domain pilot signals in accordance with an embodiment of the present invention.

Referring to FIG. 3, the base stations include PN code generators 121a, 121b, and 121c for generating PN codes, inverse fast Fourier transform (IFFT) processors 122a, 122b, and 122c for performing N-point inverse fast Fourier transform (IFFT) operations on the generated PN codes, and a delay unit 200 for delaying each IFFT signal by a multiple of a predetermined delay time. Moreover, the base stations include cyclic prefix (CP) inserters for inserting CPs into IFFT signals delayed by the delay unit 200, and parallel-to-serial (P/S) converters for converting parallel streams into serial streams. For convenience, a CP inserter and a P/S converter are expressed by one functional block 124a, 124b, or 124c. However, it should be appreciated that the units can each operate separately as stand-alone units without departing from the scope of the present invention.

The delay unit 200 includes cyclic shifters 210a, 210b, and 210c for cyclically shifting the IFFT signals by a multiple of a delay interval D between pilots. Accordingly, channels of neighboring base stations appear in delay intervals along the time axis.

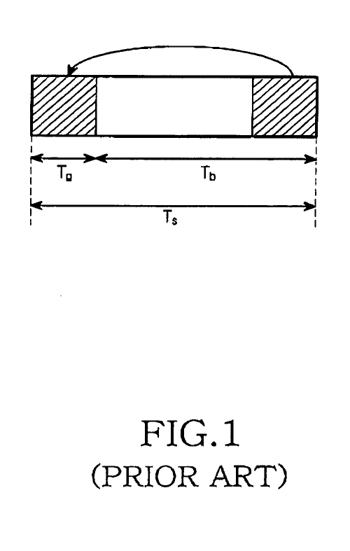

The CP inserters 124a, 124b, and 124c insert, into symbols, CPs longer than the length of a communication channel. The P/S converters 124a, 124b, and 124c convert the symbols into which the CPs have been inserted into serial streams. Output stages (not illustrated) after the P/S converters 124a, 124b, and 124c output time domain pilots to be transmitted sequentially such as on a base station-by-base station basis. That is, values x_{c,K}[n] into which the CPs have been inserted are output. In x_{c,K}[n], c indicates that a CP has been attached, K is a base station index, and n is a time index. As illustrated in FIG. 1, the CP is inserted by copying a rear part of a symbol and inserting the copied part into a front part of the symbol associated with a guide time T_{g}.

A pilot generation method and a link gain estimation method will be described with reference to the accompanying drawings. First, the pilot generation method will now be described.

A base station's transmitter loads a PN code to a frequency domain signal, and transforms, into a time domain signal, the frequency domain signal to which the PN code has been loaded using IFFT. Subsequently, the base station's transmitter cyclically shifts the time domain signal by a multiple of a delay time D between pilots and generates a time domain pilot to be transmitted. In this case, a delayed signal δ[n-lD] corresponds to a frequency domain signal e^{-j(2π/N)klD}, where N is the number of FFT points, k is a subcarrier index, l is a channel length, D is a basic unit of delay time between pilots, and n is a time index.

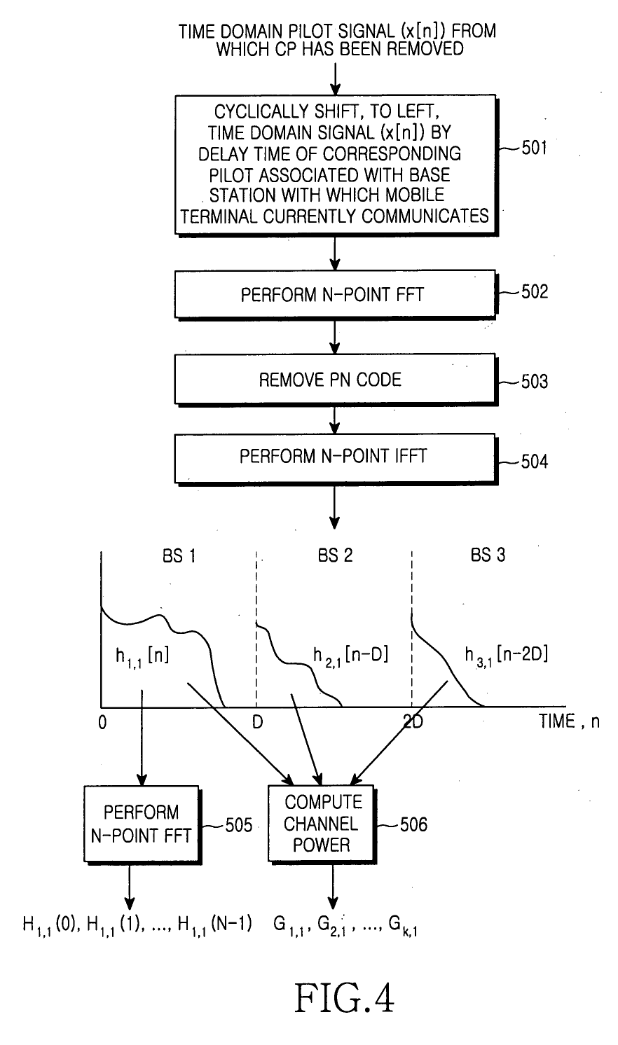

Next, the channel estimation method will be described with reference to FIG. 4.

FIG. 4 illustrates a process for computing channel estimates and link gain estimates from received pilot signals in a mobile terminal in accordance with an embodiment of the present invention.

The channel estimation process is the inverse process of the pilot generation process. In step 501, the mobile terminal cyclically shifts, to the left, a received time domain signal from which a CP has been removed according to a pilot delay time associated with a base station with which the mobile terminal desires to communicate. In step 502, the mobile terminal transforms the cyclically shifted time domain signal into a frequency domain signal using FFT. In step 503, the mobile terminal multiplies the frequency domain signal by the same PN code as that generated from the base station to remove the PN code effect. In step 504, the mobile terminal transforms the frequency domain signal into a time domain signal using IFFT after removing the PN code, such that a desired channel appears in a time period 0-D on the time axis, and interference channels subsequent to the desired channel appear in time intervals D. In step 505, the mobile terminal re-performs FFT operations on time domain IFFT signals to obtain channel estimates H_{i,j}(0), H_{i,j}(1), . . . , H_{i,j}(N−1) on a base station-by-base station basis. In step 506, the mobile terminal obtains link gain estimates G_{1,1}, G_{2,1}, . . . G_{K,1} by computing channel power values between the mobile terminal and the base stations. H_{i,j} denotes a channel estimate between Base Station i and Mobile Terminal j, and G_{2,1} denotes a link gain estimate between Base Station 2 and Mobile Terminal 1.

FIG. 5 is a block diagram illustrating base stations for transmitting time domain pilot signals in accordance with an embodiment of the present invention.

Referring to FIG. 5, a delay unit 220 is arranged between PN code generators 121a, 121b, and 121c and IFFT processors 122a, 122b, and 122c.

The delay unit 220 includes multipliers 220a, 220b, and 220c for multiplying PN code signals generated from the base stations by frequency domain signals e^{-j(2π/N)klD} corresponding to delayed signals δ[n-lD].

The IFFT processors 122a, 122b, and 122c receive the delayed PN code signals and perform IFFT operations on the received delayed PN code signals to output IFFT signals x_{K}[n](K=1, . . . , K).

CP inserters 124a, 124b, and 124c insert CPs into IFFT signals of the IFFT processors 122a, 122b, and 122c according to guide times T_{g}. P/S converters 124a, 124b, and 124c convert, into serial streams, parallel streams into which the CPs have been inserted. Output stages (not illustrated) after the P/S converters 124a, 124b, and 124c output time domain pilot signals on the base station-by-base station basis. That is, the time domain pilot signals x_{c,K}[n](K=1, . . . , K) into which the CPs have been inserted are output.

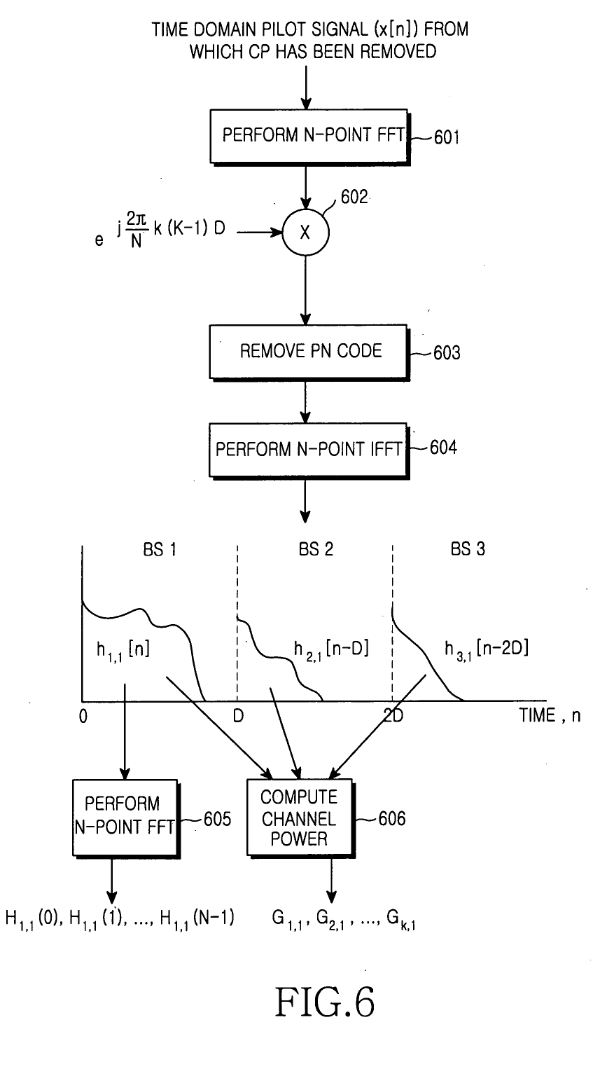

A process for receiving pilot signals from base stations and computing channel estimates and link gain estimates in a mobile terminal will be described with reference to FIG. 6.

FIG. 6 illustrates the process for computing channel estimates and link gain estimates from received pilot signals in the mobile terminal in accordance with an embodiment of the present invention.

In step 601, the mobile terminal transforms, into a frequency domain signal, a time domain signal from which a CP has been removed using N-point FFT. In step 602, the mobile terminal multiplies the FFT signal by a frequency domain signal

$${ⅇ}^{j \frac{2 π}{N} k ( K - 1 ) D}$$

corresponding to a cyclically delayed signal δ[n-lD] as in the pilot generation process. In step 603, the mobile terminal multiples the FFT signal by the same PN code as that generated from the base station to remove the PN code effect. In step 604, the mobile terminal transforms the frequency domain signal into a time domain signal using IFFT after removing the PN code, such that a desired channel appears in a time period 0˜D on the time axis, and interference channels subsequent to the desired channel appear in time intervals D. In step 605, the mobile terminal re-performs FFT operations on time domain IFFT signals to obtain channel estimates H_{i,j}(0), H_{i,j}(1), . . . , H_{i,j}(N−1) on the base station-by-base station basis. In step 606, the mobile terminal obtains link gain estimates G_{1,1}, G_{2,1}, . . . , G_{K,1} by computing channel power values between the mobile terminal and the base stations. H_{i,j} denotes a channel estimate between Base Station i and Mobile Terminal j, and G_{2,1} denotes a link gain estimate between Base Station 2 and Mobile Terminal 1.

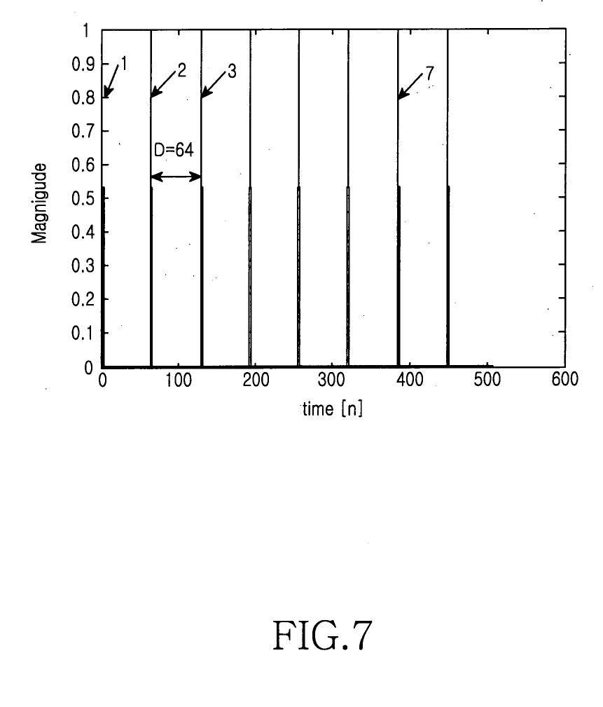

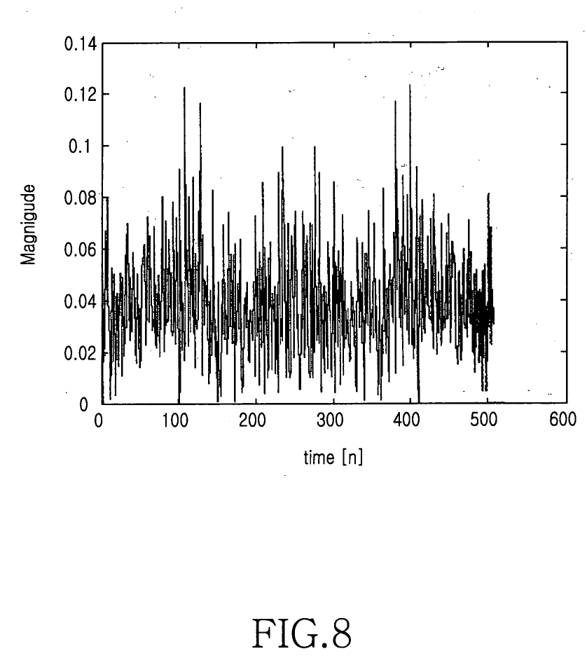

FIG. 7 is a graph illustrating delayed signals assigned to cells in accordance with an embodiment of the present invention, and illustrating time domain pilot signals when no PN code is applied. In the graph, “1” to “7” denote the base stations 21 to 27, respectively. In the pilot signal cell arrangement, pilot signals associated with the number of FFT points N (=512), a channel length value L (=8), the number of base stations K (=7), and a delay interval D (=64) between pilots are arranged in the order of Cells 1 to 7, that is, the base stations 21 to 27. If the same PN code is applied along the frequency axis, a time domain pilot signal sent from the base station 21 is illustrated as shown in FIG. 8.

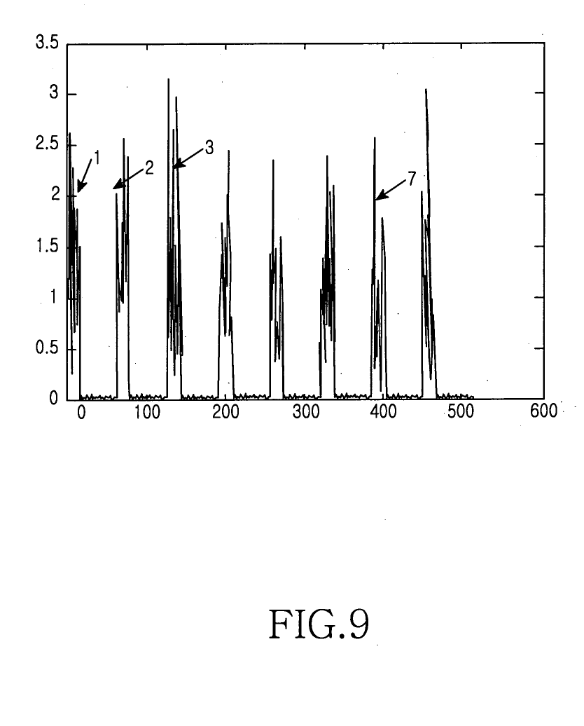

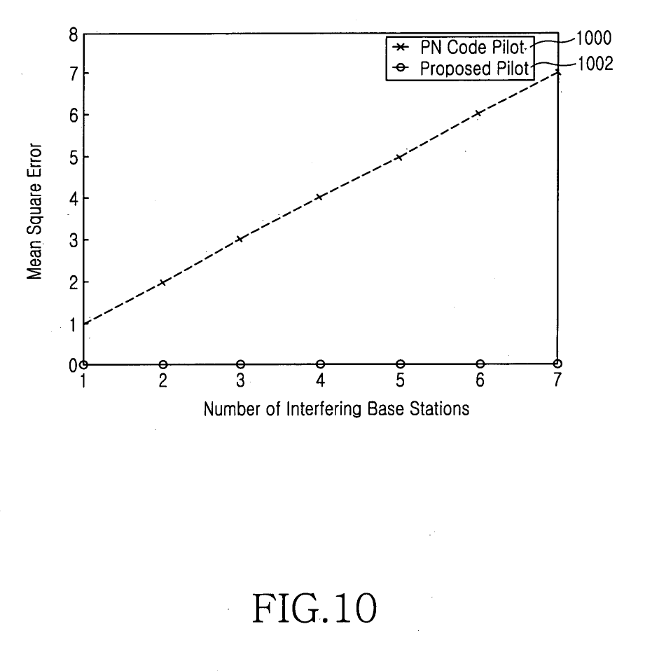

If test channels based on a channel length value of 8 and the same path gain are generated, time domain signals after IFFT for channel estimation of the mobile terminal are illustrated as in the graph of FIG. 9. If the accurate channel length is known to the mobile terminal when a signal-to-noise ratio is 3 dB, a channel estimation result using proposed pilot signals are illustrated as in the graph of FIG. 10.

FIG. 10 illustrates a comparison of pilot signals using different PN codes in accordance with an embodiment of the present invention and pilot signals using different PN codes in accordance with the prior art. When the present invention uses the proposed pilot signals, a small channel estimation error occurs regardless of an increased number of interfering base stations as indicated by reference numeral 1002 because interference components from the base stations are almost completely removed after IFFT. However, when the prior art uses the conventional pilot signals of different PN codes between the base stations, it increases a channel estimation error according to an increased number of interfering base stations as indicated by reference numeral 1000.

As apparent from the above description, embodiments of the present invention can appropriately provide pilots, individually separate interference components and link gains between a mobile terminal and base stations, provide information necessary for a centralized power control algorithm through pilot estimation, and remove interference correlated with an estimation error by defining the power of interference components in a specific time domain, such that an improved channel estimate can be obtained by increasing a signal-to-noise ratio when a channel is estimated.

Although embodiments of the present invention have been disclosed for illustrative purposes, those skilled in the art will appreciate that various modifications, additions and substitutions are possible, without departing from the scope of the present invention. Therefore, the present invention is not limited to the above-described embodiments, but is defined by the following claims, along with their full scope of equivalents.

1. An apparatus for transmitting a pilot signal in an orthogonal frequency division multiple access (OFDM) system, comprising:
pseudo random (PN) code generator for generating a frequency domain pilot signal using a PN code;
inverse fast Fourier transform (IFFT) processor for transforming the frequency domain pilot signal into a time domain pilot signal; and
a delay unit for delaying the time domain pilot signal by a predetermined time.

2. The apparatus of claim 1, further comprising cyclic prefix (CP) inserter for inserting CP into the delayed pilot signal.

3. The apparatus of claim 1, further comprising parallel-to-serial (P/S) converter for converting parallel streams into a serial stream.

4. The apparatus according to claim 1, wherein the delay unit performs a cyclic shift on the time domain pilot signal by a predetermined multiple of a time interval between pilot signals of each base station.

5. The apparatus according to claim 4, wherein the cyclic shift delays the time domain pilot signal by δ[n-lD], where n is a time index, l is a channel length, and D is a basic unit of delay time between pilots.

6. A method for transmitting a pilot signal in an orthogonal frequency division multiple access (OFDM) system, comprising:
generating a frequency domain pilot signal using a pseudo random (PN) code;
transforming the frequency domain pilot signal into a time domain pilot signal; and
delaying the time domain pilot signal by a predetermined time.

7. The method of claim 6, further comprising the step of inserting cyclic prefix (CP) into the delayed pilot signal.

8. The method of claim 6, further comprising the step of converting parallel streams into serial a stream.

9. The method according to claim 6, wherein delaying comprises:
performing cyclic shift on the time domain pilot signal by a predetermined multiple of a time interval between pilot signals of the base stations.

10. The method according to claim 9, wherein the cyclic shift comprises:
delaying the time domain pilot signal by δ[n-lD], where n is a time index, l is a channel length, and D is a basic unit of delay time between pilots.

11. An apparatus for transmitting a pilot signal in an orthogonal frequency division multiple access (OFDMA) system, comprising:
pseudo random (PN) code generator for generating a frequency domain pilot signal using a PN code;
a delay unit for multiplying the pilot signal by a predetermined phase delayed signal; and
inverse fast Fourier transform (IFFT) processor for transforming the phase delayed pilot signal into a time domain pilot signal;

12. The apparatus of claim 11, further comprising cyclic prefix (CP) inserter for inserting CP into the delayed pilot signal.

13. The apparatus of claim 11, further comprising parallel-to-serial (P/S) converter for converting parallel streams into a serial stream.

14. The apparatus according to claim 11, wherein the phase delayed signal is a frequency domain phase delayed signal corresponding to a delayed signal based on a time interval between pilots of the base stations.

15. The apparatus according to claim 14, wherein the phase delayed signal is a frequency domain signal e^{-j(2π/N)klD} corresponding to a delayed signal δ[n-lD], where N is the number of fast Fourier transform (FFT) points, k is a subcarrier index, l is a channel length, D is a basic unit of delay time between pilots, and n is a time index.

16. A method for generating a pilot signal in an orthogonal frequency division multiple access (OFDM) system, comprising:
generating a frequency domain pilot signal using pseudo random (PN) code;
multiplying the pilot signal by a predetermined phase delayed signal; and
transforming the phase delayed pilot signal into a time domain pilot signal.

17. The method of claim 16, further comprising the step of inserting cyclic prefix (CP) into the delayed pilot signal.

18. The method of claim 16, further comprising the step of converting parallel streams into a serial stream.

19. The method according to claim 16, wherein the phase delayed signal is a frequency domain phase delayed signal corresponding to a delayed signal based on a time interval between pilots of the base stations.

20. The method according to claim 19, wherein the phase delayed signal is a frequency domain signal e^{-j(2π/N)klD} corresponding to a delayed signal δ[n-lD], where N is the number of fast Fourier transform (FFT) points, k is a subcarrier index, l is a channel length, D is a basic unit of delay time between pilots, and n is a time index.

21. An apparatus for receiving a pilot signal, comprising:
RF (radio frequency) unit for receiving a transmitted radio signal;
fast Fourier transform (FFT) processor for transforming a time domain pilot signal into a frequency domain signal;
delay unit for multiplying the frequency domain signal by a signal with a phase opposite to that of a phase delayed pilot signal associated with a base station; and
pseudo random (PN) code remover for multiplying a signal output from the delay unit by the same PN code as that of the base station.

22. The apparatus of claim 21 further comprising cyclic prefix (CP) remover for removing a cyclic prefix (CP) from a time domain pilot signal.

23. The apparatus of claim 21 further comprising an inverse fast Fourier transform (IFFT) processor for transforming, into a time domain signal, the signal from which the PN code has been removed.

24. The apparatus according to claim 23, further comprising:
an estimator for performing channel estimation by using the output of the inverse fast Fourier transform (IFFT) processor.

25. A method for receiving a pilot signal comprising:
receiving a transmitted radio signal;
transforming a time domain pilot signal into a frequency domain signal;
multiplying the frequency domain signal, multiplied by a signal with the phase opposite to that of the phase delayed pilot signal, by the same pseudo random (PN) code as that of the base station; and
pseudo random (PN) code removing by multiplying the frequency domain signal by the same PN code as that of the base station

26. The method of claim 25, further comprising the step of removing a cyclic prefix (CP) from the time domain pilot signal.

27. The method of claim 25, further comprising the step of transforming, into a time domain signal, the frequency domain signal from which the PN code has been removed.

28. The method according to claim 27, further comprising performing channel estimation by using the time domain signal.

29. An apparatus for receiving a pilot signal comprising:
RF (radio frequency) unit for receiving a transmitted radio signal.
a delay unit for cyclically shifting the time domain pilot signal in a reverse direction of cyclic shift for a delay in a base station;
a fast Fourier transform (FFT) processor for transforming the cyclically shifted signal into a frequency domain signal; and
a pseudo random (PN) code remover for multiplying the frequency domain signal by the same PN code as that of the base station; and

30. The apparatus of claim 29, further comprising cyclic prefix (CP) remover for removing a cyclic prefix (CP) from a time domain pilot signal.

31. The apparatus of claim 29, further comprising an inverse fast Fourier transform (IFFT) processor for transforming, into a time domain signal, the signal from which the PN code has been removed.

32. The apparatus according to claim 31, further comprising an estimator for performing channel estimation by using the time domain signal.

33. A method for receiving a pilot comprising:
receiving a transmitted radio signal.
cyclically shifting the time domain pilot signal in a reverse direction of cyclic shift for a delay in a base station;
transforming the cyclically shifted signal into a frequency domain signal; and
multiplying the frequency domain signal by the same pseudo random (PN) code as that of the base station.

34. The method of claim 33, further comprising the step of removing a cyclic prefix (CP) from a time domain pilot signal.

35. The method of claim 33, further comprising the step of transforming into a time domain signal, the signal from which the PN code has been removed.

36. The method according to claim 35, further comprising performing channel estimation by using the time domain signal.
